(19) United States
(12) Patent Application Publication
(10) Pub. No.: US 2012/0243716 A1
(43) Pub. Date: Sep. 27, 2012

(54) HEARING APPARATUS WITH FEEDBACK CANCELER AND METHOD FOR OPERATING THE HEARING APPARATUS

(75) Inventor: HENNING PUDER, ERLANGEN (DE)

(73) Assignee: SIEMENS MEDICAL INSTRUMENTS PTE. LTD., SINGAPORE (SG)

(21) Appl. No.: 13/429,709

(22) Filed: Mar. 26, 2012

(30) Foreign Application Priority Data
Mar. 25, 2011 (DE) 102011006129.0

(51) Int. Cl. H04R 25/00

(52) U.S. Cl. 381/318

(57) ABSTRACT

A hearing apparatus has artifact-free, fast feedback cancelation properties. The hearing apparatus has a first microphone coupled by way of a pre-whitening filter to a feedback canceler in a first hearing device. The hearing apparatus is configured to set a frequency response of the pre-whitening filter in dependence on a signal of a second microphone of the hearing apparatus.

### CROSS-REFERENCE TO RELATED APPLICATION

This application claims the priority, under 35 U.S.C. §119, of German application DE 10 2011 006 129.0, filed Mar. 25, 2011; the prior application is herewith incorporated by reference in its entirety.

### BACKGROUND OF THE INVENTION

### Field of the Invention

The invention relates to a hearing apparatus, in which a microphone is coupled by way of a pre-whitening filter to a feedback canceler. The term hearing apparatus is used here in particular to refer to a hearing aid. However the term also covers other wearable acoustic devices such as headsets, headphones and the like.

Hearing aids are wearable hearing apparatuses, which are used to assist people with impaired hearing. Different models of hearing aid are available to meet the numerous individual needs. They can include hearing devices such as behind the ear (BTE) hearing devices, hearing devices with an external earpiece (RIC: receiver in the canal) and in the ear (ITE) hearing devices, for example also concha hearing devices or canal hearing devices (ITE, CIC). The hearing devices listed by way of example are worn on the outer ear or in the auditory canal. However bone conduction hearing aids, implantable or vibrotactile hearing aids are also available commercially. With these the impaired hearing is stimulated either mechanically or electrically.

In principle the key components of hearing devices are an input transducer, an amplifier and an output transducer. The input transducer is generally a sound receiver, e.g. a microphone, and/or an electromagnetic receiver, e.g. an induction coil. The output transducer is generally configured as an electroacoustic transducer, e.g. a miniature loudspeaker, or as an electromechanical transducer, e.g. a bone conduction earpiece. The amplifier is generally integrated in a signal processing unit. This basic structure is shown in FIG. 1 based on the example of a behind the ear hearing device. Contained in a hearing device housing 1 to be worn behind the ear are one or more microphones 2 to receive sound from the environment. A signal processing unit 3, which is also integrated in the hearing device housing 1, processes the microphone signals and amplifies them. The output signal of the signal processing unit 3 is transmitted to a loudspeaker or earpiece 4, which outputs an acoustic signal. In some instances the sound is transmitted by way of a sound tube, which is fixed by an otoplastic in the auditory canal, to the eardrum of the device wearer. Instead of an otoplastic a domed ear mold, referred to as a dome, can also be used, which, when inserted into the auditory canal, molds itself to the shape thereof. What is known as a tip is often used in conjunction with open molding, the tip having a particularly narrow shape so as not to impair ventilation of the auditory canal. Energy is supplied to the hearing device and in particular to the signal processing unit 3 by a battery 5, which is also integrated in the hearing device housing 1.

With acoustic feedback some of the sound produced by the earpiece 4 (as air-born or structure-born sound) passes by way of feedback path back to at least one of the microphones 2. This can cause the hearing device 1 to produce an unwanted whistling noise. To avoid such a whistling noise, a feedback canceler can be provided, which can be for example part of the signal processing unit 3.

To cancel a whistling noise successfully, a model of the feedback path must first be adapted in the feedback canceler. During adaptation unwanted artifacts can be produced, which are perceptible in the sound signal of the earpiece. Microphone signals with a tonal component are particularly prone to such artifact formation.

It is known that to resolve this in theory the microphone can be coupled by way of a pre-whitening filter to the feedback canceler. A pre-whitening filter here refers to a filter that reduces differences between the amplitudes of individual frequency components within a short-time spectrum of a microphone signal. This is also referred to as whitening of the short-time spectrum. Such leveling of the short-time spectrum corresponds to a reduction of the autocorrelation of the signal, i.e. its decorrelation. The tonality of the microphone signal in particular is reduced. For ideal whitening the frequency response of a pre-whitening filter corresponds to the inverted short-time spectrum of the signal to be whitened.

Use of a pre-whitening filter has the disadvantage that leveling also causes the spectral peaks in the short-time spectrum of the microphone signal which are characteristic of the feedback whistling noise to be attenuated. This makes the adaptation of the model in the feedback canceler problematic due to the then only poorly characterized spectral peaks. In particular it becomes very slow.

### SUMMARY OF THE INVENTION

It is accordingly an object of the invention to provide a hearing apparatus with a feedback canceler and a method for operating the hearing apparatus which overcome the above-mentioned disadvantages of the prior art methods and devices of this general type, which allows artifact-free, fast feedback cancelation in the hearing apparatus.

With the inventive hearing apparatus a first microphone is coupled by way of a pre-whitening filter to a feedback canceler. The hearing apparatus also has a second microphone. The hearing apparatus is configured to set a frequency response of the pre-whitening filter (for the first microphone) as a function of a signal of the second microphone.

To operate the inventive hearing apparatus in a first step the inventive method provides for capturing a first microphone signal of the first microphone and a second microphone signal of the second microphone. The first microphone signal is filtered by the pre-whitening filter. A frequency response of the pre-whitening filter for the first microphone signal is set here in dependence on the second microphone signal. The feedback canceler for the first microphone signal is then adapted on the basis of the filtered first microphone signal.

The inventive hearing apparatus and the inventive method have the advantage that in the case of feedback in the first microphone signal the feedback canceler is quickly adapted and yet no artifacts result during adaptation. Adaptation of the feedback canceler here and in the following refers to the adaptation of the model used by the feedback canceler for the feedback path.

The artifacts are prevented by the pre-whitening filter. However because the frequency response of the pre-whitening filter is set on the basis of the second microphone signal, in which no (or at least a different) feedback component is contained, there is no attenuation of the spectral peaks in the short-time spectrum of the first microphone signal when the first microphone signal is filtered during feedback. This allows fast adaptation of the feedback canceler.

To set the frequency response of the pre-whitening filter, it can be coupled to an adaptive filter, which is configured to determine filter coefficients for pre-whitening filtering as a function of the microphone signal of the second microphone. The pre-whitening filter then receives the filter coefficients from the adaptive filter and sets the frequency response based on the filter coefficients. The filter coefficients here are also preferably determined in a correspondingly adaptive fashion, i.e. continuously. The appropriate filter coefficients are therefore always available in the event of a change in the short-time spectrum of the ambient sound signal.

The filter coefficients, or more generally the frequency response, can be set for example on the basis of a least-mean-square algorithm or the Levinson-Durbin algorithm or a linear prediction or an autocorrelation determination.

The hearing apparatus is advantageously developed if the feedback canceler has a shadow filter. A shadow filter can be used to avoid noise and stability problems in particularly critical acoustic environments. As an alternative to a shadow filter an estimation facility for a feedback path can also be integrated in a useful signal path in the feedback canceler. Such integration means that fewer filters have to be provided to bring about adaptive feedback cancelation.

Another advantageous development results, if the first microphone is disposed in a component of the hearing apparatus to be worn in an appropriate manner on an ear of a user of the hearing apparatus, e.g. a hearing device, and the second microphone is disposed at a distance from this component. The distance means that it is very unlikely that feedback will occur with a whistling noise at a certain frequency in both microphones. This ensures that attenuation of the feedback component, i.e. the spectral peaks in the short-time spectra of the first microphone signal, is not caused by pre-whitening.

It is particularly advantageous if the two microphones are disposed in components of the hearing apparatus, which are to be worn on different sides of the head of a user, in other words for example in two hearing devices. This development is based on the observation that feedback almost never results at the same time for the same frequency in both components. In contrast the ambient sound signals received by both components are always very similar. Whitening of the signal component of the ambient sound in the first microphone signal is therefore possible with the aid of a pre-whitening filter, the frequency response of which is determined on the basis of the second microphone signal. The signal component produced by local feedback into the first microphone is not attenuated here. Head shadowing means that the feedback signal occurring at one of the hearing devices does not reach the other or only reaches it with significant attenuation, so that its pre-whitening filter features no attenuation in the feedback signal.

Other features which are considered as characteristic for the invention are set forth in the appended claims.

Although the invention is illustrated and described herein as embodied in a hearing apparatus with a feedback canceler and a method for operating the hearing apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic diagram of a behind the ear hearing device according to the prior art;

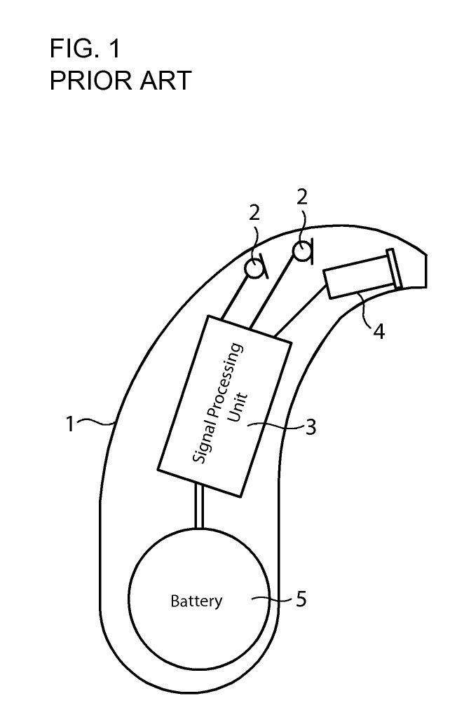

FIG. 2 is a block diagram of a binaural hearing aid according to one embodiment of the hearing apparatus according to the invention;

FIG. 3 is a diagram of two graphs each showing frequency responses of pre-whitening filters, a filter coefficients of which were determined without feedback in each instance;

FIG. 4 is an illustration of three diagrams each of two graphs of frequency responses of pre-whitening filters, the coefficients of which were determined once during feedback and once without feedback;

FIG. 5 is a block diagram of a hearing device of the hearing aid from FIG. 2; and

FIG. 6 is a block diagram of the hearing device of a binaural hearing aid according to a further embodiment of the hearing apparatus according to the invention.

### DETAILED DESCRIPTION OF THE INVENTION

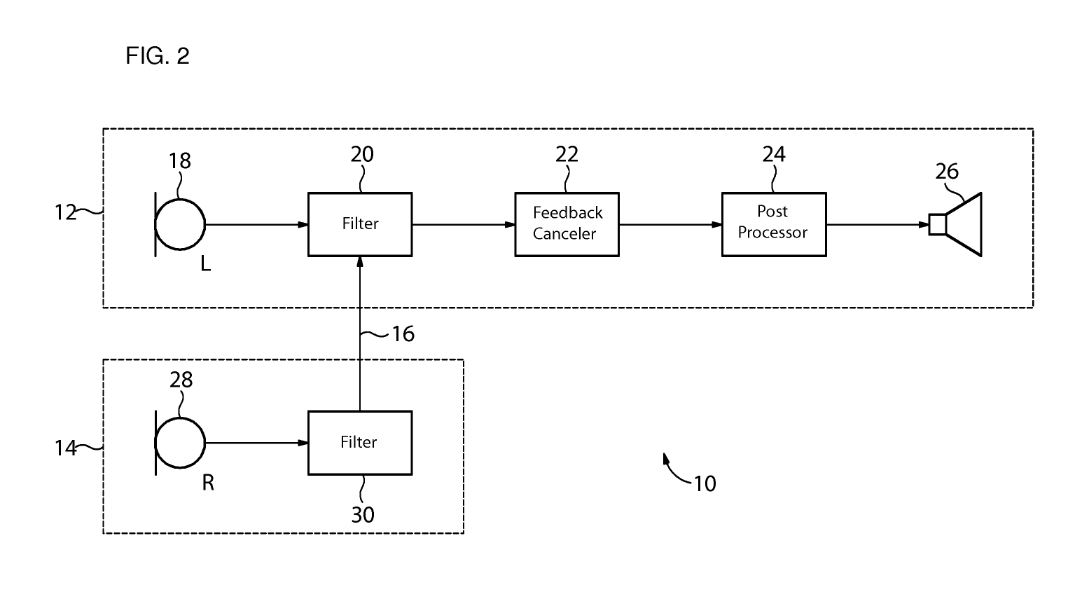

Referring now to the figures of the drawing in detail and first, particularly, to FIG. 2 thereof, there is shown a block diagram of a binaural hearing aid 10. The hearing aid 10 has components in the form of a left hearing device 12 and a right hearing device 14, which are to be worn in each instance on the ear by a user of the hearing aid 10. In FIG. 2 the letters L (left) and R (right) indicate the side of the head on which the hearing devices are to be worn. The hearing devices 12 and 14 can be for example in the ear hearing devices or behind the ear hearing devices.

The two hearing devices 12 and 14 are connected to one another by way of a communication connection 16. This can be a cable or a radio connection for example. Audio signals or other data for example can be exchanged between the hearing devices 12 and 14 by way of the communication connection 16.

The left hearing device 12 has a first microphone 18, which is coupled by way of a pre-whitening filter 20 to a feedback canceler 22. The feedback canceler 22 is coupled by way of a post-processing facility 24 to an earpiece 26 of the hearing device 12.

Present in the right hearing device 14 is a second microphone 28, which is coupled to an adaptive filter 30. Filter coefficients determined by the adaptive filter 30 are transmitted by way of the communication connection 16 to the pre-whitening filter 20.

A microphone signal of the first microphone 18 is whitened by the pre-whitening filter 20. This reduces the tonality of the microphone signal, with the result that during adaptation of the feedback canceler 22 fewer artifacts are produced in the output signal of the feedback canceler 22.

The feedback canceler 22 can be based on an adaptive system identification, with which a feedback component is determined in the signal received from the pre-whitening filter 20 on the basis of a model of a transmission function of a local feedback path from the earpiece 26 to the microphone 18. The adaptation of the feedback canceler 22 takes place based on the feedback component contained in the microphone signal of the first microphone 18.

The frequency response of the pre-whitening filter 20, i.e. its transmission behavior, is set by filter coefficients, which the pre-whitening filter 20 receives from the adaptive filter 30.

The adaptive filter 30 determines the filter coefficients on the basis of a microphone signal of the second microphone 28.

The filter coefficients can be determined for example on the basis of a linear prediction. Instead of a linear prediction it is also possible for example to use the Levinson-Durbin algorithm or generally a method for determining an autocorrelation function of the microphone signal. In the spectral range an inversion of an auto power density spectrum of the microphone signal for example is a method for determining a pre-whitening filter.

The adaptive filter 30 can also be part of the left hearing device 12.

The post-processing facility 24 reverses the signal distortion brought about by the pre-whitening filter 20 in the microphone signal, i.e. by whitening. For such equalization the output signal of the feedback canceler 22 can be processed for example using a filter, the transmission function of which is formed by inverting a current transmission function of the pre-whitening filter 20.

The post-processing facility 24 also contains an amplifier, which amplifies the equalized signal to operate the earpiece 24.

Feedback cancelation is also permitted in the hearing aid 10 for an earpiece (not shown) of the right hearing device 14. To this end the right hearing device 14 also has a pre-whitening filter and a feedback canceler, neither of which are shown in FIG. 2 for the sake of clarity. Filter coefficients for the pre-whitening filter of the right hearing device 14 are determined by way of a second adaptive filter on the basis of the microphone signal of the first microphone 18.

Pre-whitening by the pre-whitening filter 20 can also be combined with frequency shifting. This has the advantage that the feedback canceler 22 is particularly robust against artifact formation. Frequency shifting can be brought about for example by single sideband modulation, for example by a Hilbert filter. The shift can amount to 20 Hz for example.

It should be assumed in the following for the example described in FIG. 2 that some of the sound produced by the earpiece 26 is fed back into the first microphone 18, so that a signal component of ambient sound and a signal component of the feedback are contained in the microphone signal of the first microphone 18. The second microphone 28 likewise captures ambient sound. The signal component of the feedback is in contrast not contained in the microphone signal of the second microphone 28 because of shielding by the head of the user.

Because the whitening of the microphone signal of the first microphone 18 takes place on the basis of the filter coefficients from the adaptive filter 30, the signal component of the feedback in the microphone signal of the first microphone 18 is not attenuated. The feedback canceler 22 therefore adapts quickly enough to prevent the occurrence of a whistling noise. Artifact formation is still greatly reduced or even completely prevented.

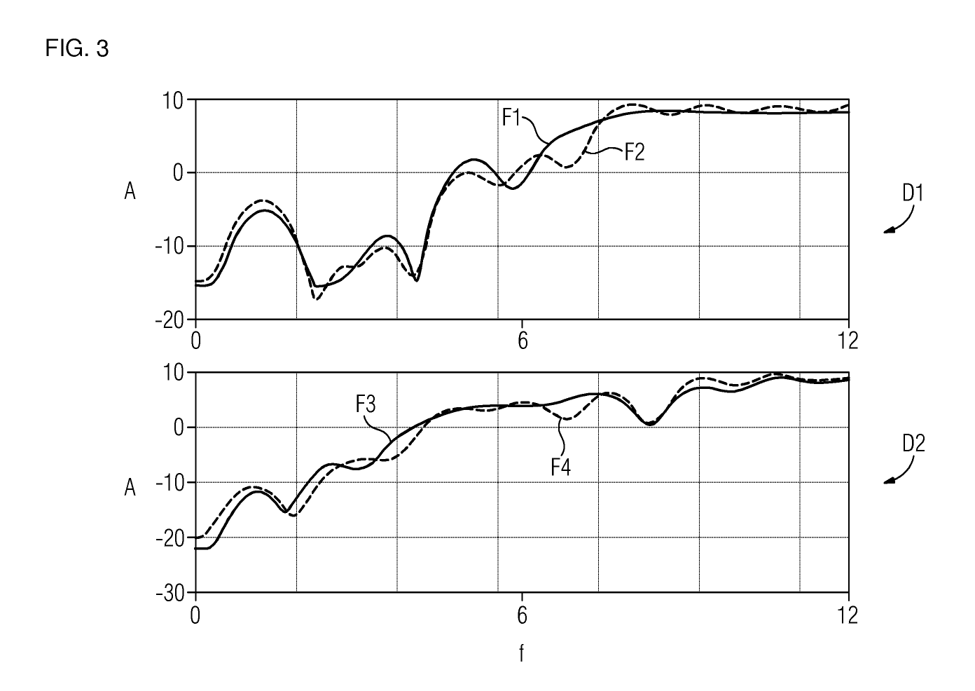

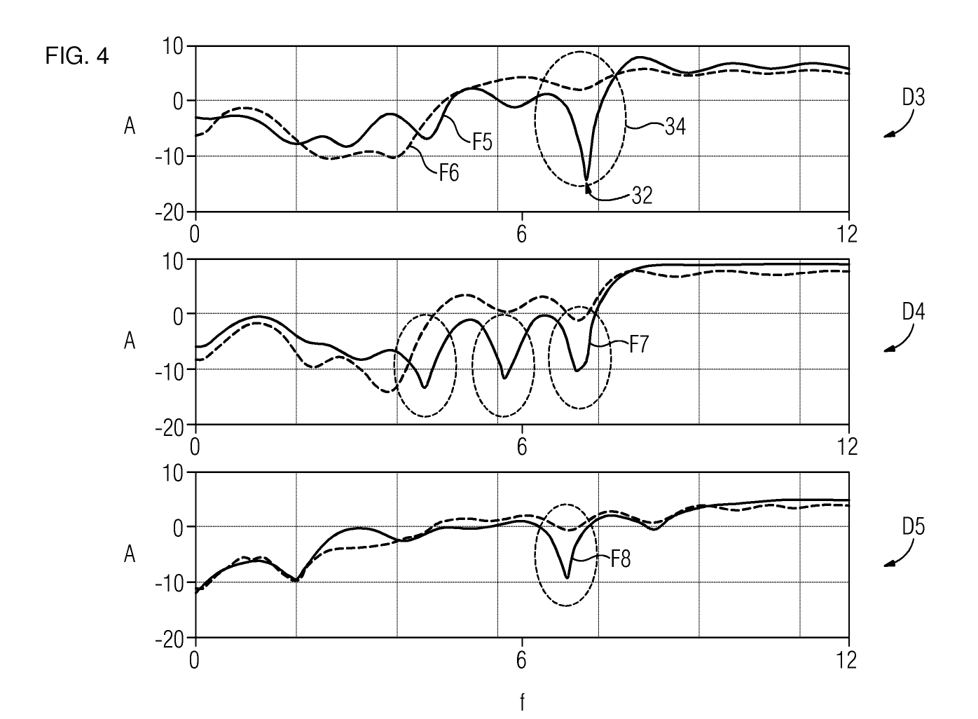

Prevention of the slowing of the adaptation of the feedback canceler 22 is described again in more detail below with reference to FIG. 3 and FIG. 4.

Two diagrams D1 and D2 are shown in FIG. 3 for this purpose. Both diagrams D1, D2 show two graphs of frequency responses of pre-whitening filters. The abscissa axis of the diagrams D1 and D2 shows the frequency f (in kilohertz), the ordinate axis shows the amplitude A (in decibels).

Diagram D1 shows a frequency response F1 and a frequency response F2. The frequency response F1 was determined on the basis of the microphone signal of the microphone 18 of the left hearing device 12, the frequency response F2 on the basis of the microphone signal of the microphone 28 of the right hearing device 14. Ambient sound was captured by both microphones 18, 28. Feedback was not present in both hearing devices 12, 14.

The filter coefficients underlying the frequency responses were determined in the case of the frequency response F2 by the adaptive filter 30 (right microphone signal) and in the case of the frequency response F1 by the adaptive filter of the left hearing device 12 (left microphone signal).

As shown in diagram D1, very similar frequency responses F1 and F2 result for both microphone signals. It is therefore possible to use the filter coefficients, which produce the frequency response F2 (right microphone signal), to whiten the microphone signal of the left microphone by the pre-whitening filter 20. Similarly the filter coefficients for the frequency response F2 (left microphone signal) can be used without any problem in the pre-whitening filter of the right hearing device 14.

Diagram D2 shows frequency responses F3 and F4. The frequency response F3 corresponds to the frequency response F1, as results at a different time, when the adaptive filter has adjusted to a change in the ambient sound. The frequency response F4 corresponds to the frequency response F2 at the different time.

It can be seen from the diagram D2 that very similar frequency responses always result for both microphones 18, 28 even at a different time.

FIG. 4 shows three diagrams D3, D4 and D5 respectively of further frequency responses, which were determined based on the microphone signals of the left microphone 18 and of a right microphone 28. Diagrams D3 to D5 again show frequency responses resulting at respectively different times. In contrast to the diagrams from FIG. 3, the diagrams D3 to D5 show frequency responses for pre-whitening filters that result when acoustic feedback is present at the left hearing device 12, due to which one or more whistling noises are produced by the left hearing device 12.

Diagram D3 shows a frequency response F5 for a pre-whitening filter, which was determined on the basis of the left microphone signal. The frequency response F5 shows a marked dip 32. The dip 32 is located at the frequency of a whistling noise caused by the feedback. If the filter coefficients producing the frequency response F5 were also used to whiten the left microphone signal in the pre-whitening filter 20, the dip 32 would cause this to result in a significant attenuation of the signal component originating from the feedback, in other words the spectral peak caused by the whistling noise in the short-time spectrum of the microphone signal of the left microphone 18 would be attenuated. Adaptation of the downstream feedback canceler 22 would slow down correspondingly.

A frequency response F6, which was determined on the basis of the microphone signal of the right hearing device 14 by the adaptive filter 30, is not influenced by the feedback in a frequency range 34, in which the frequency of the whistling noise is located. The frequency response F6 therefore only represents ambient sound. It is therefore possible with the filter coefficients from the adaptive filter 30 to whiten the left microphone signal by the pre-whitening filter 20, without attenuating the signal component originating from the feedback in the process. This allows fast yet artifact-free feedback cancelation.

Diagrams D4 and D5 respectively once again show frequency responses corresponding to the frequency responses F5 and F6, as result for two other ambient sound signals. The feedback at the left hearing device 12 always causes dips only in the frequency response F7, F8, which was determined in the left hearing device 12 on the basis of the microphone signal of the left microphone 18.

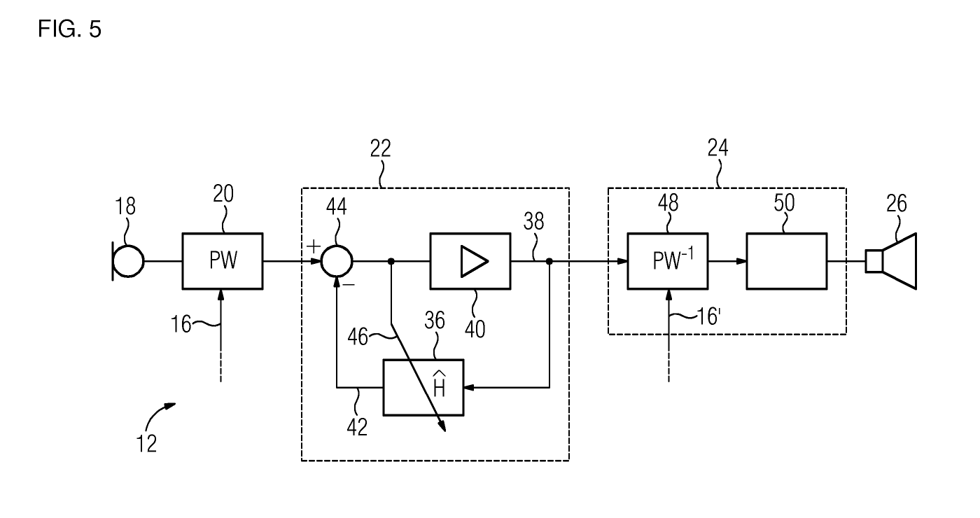

FIG. 5 again shows the left hearing device 12 of the hearing aid 10 depicted in FIG. 2 in more detail to illustrate the mode of operation of the feedback canceler 22.

The feedback canceler 22 has an estimation unit 36, which is used to determine an estimated transmission function Ĥ for a transmission function Ĥ of a feedback path. The transmission function Ĥ is referred to in the following as the estimated feedback path Ĥ. The estimated feedback path Ĥ is the above-mentioned model for the feedback path. A feedback component 42 is estimated on the basis of the estimated feedback path Ĥ from an output signal 38 of a processing unit 40.

The estimated feedback component 42 is subtracted using a calculation unit 44 from the output signal of the pre-whitening filter 20. In an ideal adaptation of the estimation unit 36, this would remove a feedback component from an output signal of the pre-whitening filter 20. The output signal of the calculation unit 44 is on the one hand transmitted as a useful signal to the processing unit 40. On the other hand the output signal forms an error signal 46 for adapting the estimation unit 36, i.e. for adapting the estimated feedback path Ĥ.

The processing unit 40 can for example bring about selective amplification of individual frequency ranges, for which the hearing capacity of the user of the hearing aid 10 is impaired.

FIG. 5 also illustrates the mode of operation of the post-processing facility 24 in more detail. For current filter coefficients PW for the pre-whitening filter 20 an adjustable filter 48 of the post-processing facility 24 uses a communication connection 16′ to receive filter coefficients PW⁻¹, which are used to set the frequency response of the adjustable filter 48. The filter coefficients PW⁻¹ produce a frequency response of the adjustable filter 48, which is the inverse of that of the pre-whitening filter 20 operated with the filter coefficients PW, so that the equalization described above is brought about by filtering the output signal 38 of the processing unit 40 using the adjustable filter 48.

The amplifier 50 then brings about the amplification of the equalized signal also described above for operation of the earpiece 26.

As already mentioned above with the hearing device 12 a single filtering of the output signal 38 with the estimation unit 36 determines a signal, namely the estimated feedback component 42, which can be used both to form the error signal 46 for the adaptation of the estimation unit 36 and to remove the feedback component from the useful signal for the earpiece 26. Estimation of the feedback path H is thus integrated in the useful signal path, which passes here from the microphone 18 by way of the pre-whitening filter 20, the calculation unit 44, the processing unit 40 and the post-processing facility 24 to the earpiece 26.

In the following an alternative embodiment of a hearing device is described in this context, with a shadow filter being used therein.

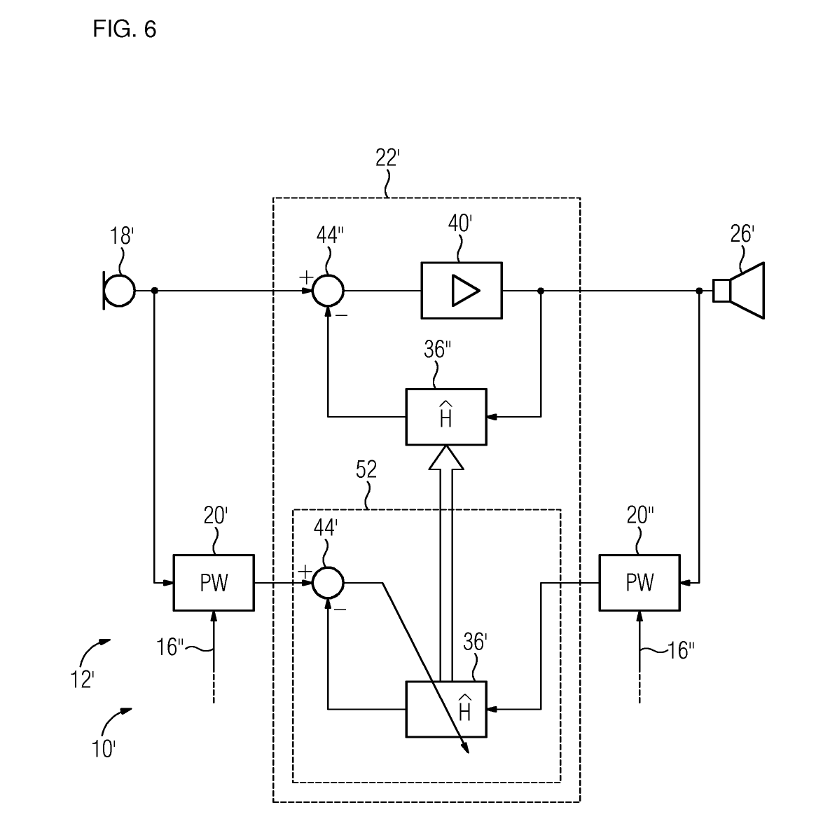

FIG. 6 shows a hearing device 12′ of a binaural hearing aid 10′ (not shown in detail). In FIG. 6 elements of the hearing device 12′, which correspond in function to elements of the hearing device 12, are assigned identical reference characters but with apostrophes.

With the hearing device 12′ the adaptation of an estimation unit 36′ can be performed on the basis of a “pre-whitened” signal, without it being necessary to filter signals with the inverted frequency response. A signal output by an earpiece 26′ therefore does not first have to be equalized in the hearing device 12′, thereby avoiding possible problems with stable operation of the inverse filter required for equalization and possible noise in the output signal. The hearing device 12′ can thus also be used in environments where whitening of a microphone signal of a microphone 18′ produces relatively significant distortion. Also filter coefficients for inverse filtering, specifically equalization, do not have to be calculated for filter coefficients PW for a pre-whitening filter 20′.

The estimation unit 36′ is part of a feedback canceler 22′ of the hearing device 12′. Together with a calculation unit 44′ it forms a shadow filter 52, which is used to estimate a feedback path Ĥ in the manner described in relation to the estimation unit 36 and the calculation unit 44. An output signal of a processing unit 40′ is returned to the estimation unit 36′ by way of a further pre-whitening filter 20″. The two pre-whitening filters 20′ and 20″ are connected by way of a communication connection 16″ to an adaptive filter (not shown), which corresponds to the adaptive filter 30. Therefore fast adaptation of the estimation unit 36′ is also ensured for the above reasons in the hearing device 12′.

In contrast to the hearing device 12, in the hearing device 12′ cancelation of a feedback component is brought about directly in the non-whitened microphone signal by a feedback filter 36″ and a calculation unit 44″. A transmission function of the feedback filter 36″, i.e. its frequency response, here corresponds to the transmission function Ĥ of the feedback path estimated by the estimation unit 36′. To this end the estimation facility 36′ transmits corresponding coefficients to the feedback filter 36″. The shadow filter 52 is thus used to determine an estimated feedback path Ĥ, without it being necessary to modify a useful signal on a useful signal path connecting the microphone 18′ to the earpiece 26′ for the purpose. Because the shadow filter 52 here processes the whitened signals of the pre-whitening filters 20′ and 20″, artifact-free processing of the microphone signal of the microphone 18′ by the feedback filter 36″ is permitted in the feedback filter 36″.

An amplifier of the hearing device 12′ provided to operate the earpiece 26′, which corresponds to the amplifier 50, is not shown in FIG. 6.

As shown in the examples, an artifact-free, fast adapting feedback cancelation is permitted for both hearing devices 12 and 14 in the hearing aid 10.

1. A hearing apparatus, comprising:
a pre-whitening filter;
a feedback canceler;
a first microphone coupled by way of said pre-whitening filter to said feedback canceler; and
a second microphone, the hearing apparatus configured to set a frequency response of said pre-whitening filter in dependence on a signal of said second microphone.

2. The hearing apparatus according to claim 1, further comprising an adaptive filter coupled to said pre-whitening filter, said adaptive filter determining filter coefficients for said pre-whitening filtering in dependence on the signal of said second microphone, said pre-whitening filter receiving the filter coefficients from said adaptive filter and setting the frequency response based on the filter coefficients.

3. The hearing apparatus according to claim 1, wherein the hearing apparatus sets the frequency response on a basis of a least-mean-square algorithm, a Levinson-Durbin algorithm, a linear prediction or an autocorrelation determination.

4. The hearing apparatus according to claim 1, wherein said feedback canceler has a shadow filter.

5. The hearing apparatus according to claim 1, further comprising a component to be worn in an appropriate manner on an ear of a user, said first microphone disposed in said component and said second microphone disposed at a distance from said component.

6. The hearing apparatus according to claim 1, further comprising components to be worn on different sides of a head of a user, said first and second microphones disposed in said components.

7. The hearing apparatus according to claim 1, wherein said feedback canceler has an estimation facility for a feedback path integrated in a useful signal path.

8. A method for operating a hearing apparatus, which comprises the steps of:
capturing a first microphone signal of a first microphone;
filtering the first microphone signal by means of a pre-whitening filter;
adapting a feedback canceler on a basis of a filtered first microphone signal;
capturing a second microphone signal of a second microphone; and
setting a frequency response of the pre-whitening filter for the first microphone signal in dependence on the second microphone signal.

9. The method according to claim 8, which further comprises determining filter coefficients which allow pre-whitening filtering of the second microphone signal, and the frequency response of the pre-whitening filter is set by means of the filter coefficients.

10. The method according to claim 9, which further comprises determining the filter coefficients adaptively.

11. The method according to claim 8, which further comprises setting the frequency response on a basis of a least-mean-square algorithm, a Levinson-Durbin algorithm, a linear prediction or an autocorrelation determination.
